(19) United States
(12) Patent Application Publication
(10) Pub. No.: US 2003/0181164 A1
(43) Pub. Date: Sep. 25, 2003

(54) APPARATUS AND METHOD FOR TRANSMITTING AND RECEIVING A SIGNAL

(76) Inventors: KEN KUTARAGI, TOKYO (JP); EIJI KAWAI, TOKYO (JP)

Correspondence Address: WILLIAM S. FROMMER, ESQ., C/O FROMMER LAWRENCE & HAUG LLP, 745 FIFTH AVENUE, NEW YORK, NY, 10151, US

(21) Appl. No.: 09/286,799

(22) Filed: Apr. 6, 1999

(30) Foreign Application Priority Data
Apr. 10, 1998 (JP) 10-099683

(51) Int. Cl. H04B 7/00

(52) U.S. Cl. 455/41.2; 455/41.3

(57) ABSTRACT

A method and apparatus for transmitting and receiving a signal. A transmission signal is transmitted from the apparatus at a first intensity level for reception by a receiving device. The apparatus includes a device for receiving a response from the receiving device indicating that the receiving device received the transmission signal. The apparatus further includes a device for re-transmitting the transmission signal at a second intensity level higher than the first intensity level when the response is not received by the apparatus after transmitting the transmission signal at the first intensity level.

### BACKGROUND OF THE INVENTION

The present invention relates to an apparatus and method for bi-directionally transmitting and receiving a signal through a radio circuit.

Infrared radiation communications wherein signals are transmitted in a wireless manner may be used in information-handling devices such as personal computers, printers, and so forth, and also in audio-video devices such as television receivers, video tape recorders, and so forth.

In infrared radiation communications, a signal may be modulated by a predetermined process and transmitted from a transmitting side or device, and such transmitted signal may be detected and demodulated by a receiving side or device. As an example, a signal may be modulated by a predetermined modulation technique, such as pulse position modulation (PPM) having a carrier frequency in a frequency range from 33 kHz to 40 kHz, and transmitted from an infrared radiation light-emitting diode and such transmitted infrared signal may be detected by a photodiode and demodulated. The power of emitted infrared radiation may be determined by the current flowing through the infrared radiation light-emitting diode which, in turn, may be determined from the specifications of the respective infrared radiation light-emitting diode.

A so-called PIN photodiode may be used to detect infrared radiation. The PIN photodiode may detect infrared radiation over a relatively wide detection area and may include a condenser lens mounted on a photo-detector for improving sensitivity so as to detect infrared radiation transmitted over a relatively large distance.

In communications between devices which communicate bidirectionally with each other with radio signals such as infrared signals, the intensity of transmitted signals is constant. This arrangement may cause transmitted signals not to be properly received and/or the transmitted signals may be subjected to adverse effects due to differences in shields, disturbance noises and so forth. For example, consider the situation in which a PIN type photodetector device is operable to detect an infrared signal transmitted from a transmitter. In such situation, a current flowing through the photodetector device may be relatively large if it is located close to the transmitter and may be relatively small if it is located further from the transmitter. In the former case the transmitted signal may be properly received, whereas in the latter case the transmitted signal may not be properly received.

Accordingly, the above-described arrangement may impose limitations on the use of the communication devices.

### OBJECTS AND SUMMARY OF THE INVENTION

An object of the present invention is to provide an apparatus and method operable for bidirectional communications which can control an intensity level at which a signal is transmitted.

Another object of the present invention is to provide an apparatus and method as aforesaid in which the signal may be re-transmitted at a higher intensity level when a response is not received at the transmitting side indicating that the previously transmitted signal was received at the receiving side.

A still further object of the present invention is to provide an apparatus and method as aforesaid in which the signal may be automatically re-transmitted at a higher intensity level when a response is not received at the transmitting side indicating that the previously transmitted signal was received at the receiving side.

In accordance with an aspect of the present invention, a communication apparatus for bidirectionally transmitting and receiving a signal through a radio circuit is provided. The apparatus comprises a transmitting device for transmitting a signal, a drive device for driving the transmitting device to transmit the signal, a control device for controlling the transmitting device and the drive device, and a signal transmission intensity control device for controlling an intensity with which the signal is transmitted.

Other objects, features and advantages according to the present invention will become apparent from the following detailed description of the illustrated embodiments when read in conjunction with the accompanying drawings in which corresponding components are identified by the same reference numerals.

### BRIEF DESCRIPTION OF THE DRAWINGS

FIG. 1 is a diagram of a signal transmitting and receiving apparatus in accordance with an embodiment of the present invention;

FIG. 2 is a diagram of a portion of the apparatus of FIG. 1;

FIG. 3 is a diagram of resistor values to which reference will be made in explaining combined values of resistors;

FIG. 4A is a flowchart to which reference will be made in explaining an operation of the apparatus of FIG. 1;

FIG. 4B is a modification to the flowchart of FIG. 4A;

FIG. 5 is a flowchart to which reference will be made in explaining another operation of the apparatus of FIG. 1; and

FIG. 6 illustrates an arrangement of communication apparatuses.

### DESCRIPTION OF THE PREFERRED EMBODIMENTS

A communication apparatus according to an embodiment of the present invention will hereinbelow be described with reference to the drawings.

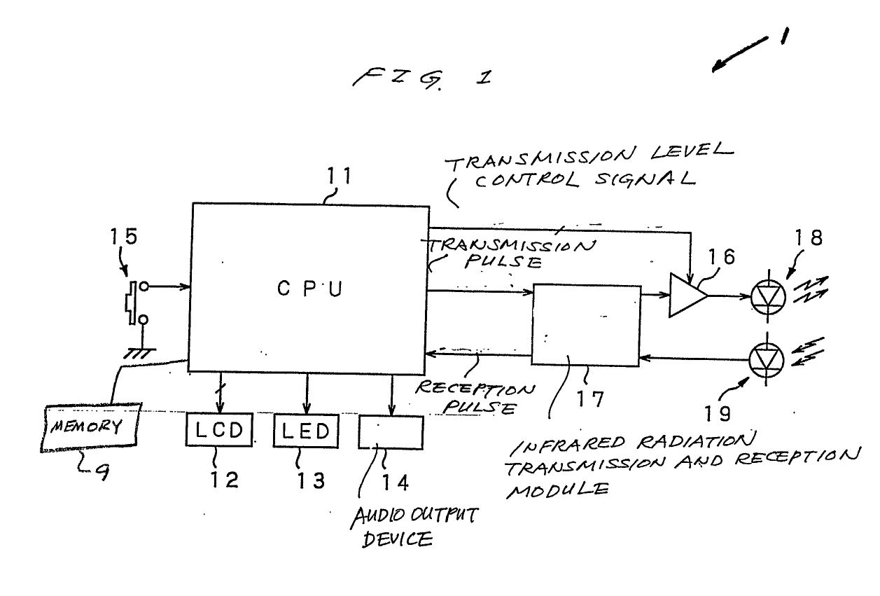

FIG. 1 illustrates a communication apparatus 1. Such apparatus 1 may include a central processing unit (CPU) 11, a liquid crystal display (LCD) 12, a light-emitting diode (LED) 13, an audio output device 14, an input device 15, an amplifier 16, an infrared radiation transmission and reception module 17, an infrared radiation light-emitting diode 18, and a photodiode 19 which may be connected as shown in FIG. 1. As hereinbelow described, the apparatus 1 enables a communication mode to be performed which may involve completing a preparation process until an effective application (hereinafter referred to as an “application mode”) such as for business or entertainment is started based on communications between a number of portable devices (such as apparatuses 1) having the ability to bidirectionally communicate with each other using radio signals or the like.

The CPU 11 may generate and supply control signals to a number of the components of the apparatus 1 so as to control operations of the same. The CPU 11 may perform processing according to a predetermined sequence stored in a memory 9, which may be a read only memory (ROM) which is a nonvolatile type memory or a random access memory (RAM) which is a volatile type memory.

The LCD 12 may include a liquid crystal panel having a two-dimensional display area for displaying characters and images. The LCD 12 may display such characters and images in accordance with a signal from the CPU 11.

The LED 13 may be activated so as to emit light in a flashing or steady state condition in accordance with a control signal from the CPU 11. Additionally, a plurality of LEDs 13 may be arranged in a predetermined pattern so as to display or provide an indication of a signal level or the like.

The audio output device 14 may be a speaker, buzzer or the like for receiving an audio signal and for outputting corresponding sounds therefrom in accordance with a control signal from the CPU 11.

As hereinafter more fully described, the communication apparatus 1 may is transmit a first signal for reception by a second communication apparatus and the second communication apparatus may transmit a second signal for reception by the first communication apparatus so as to inform such apparatus that the second communication apparatus received or did not receive the first signal. In such situation, the LCD 12, the LED 13, and/or the audio output device 14 may provide an indication to an operator as to whether or not a response has been received from the other communication apparatus.

The input device 15 may include a pushbutton-type switch adaptable to close a circuit when pressed. Alternatively, other types of devices may be utilized such as a joystick, a mouse, and a keyboard. The input device 15 may be coupled to the CPU 11 and may supply a desired or predetermined input to the CPU. That is, the input button 15 may supply an input to the CPU 11 so as to cause the level of a signal to be transmitted from the apparatus 1 for reception by another such apparatus to be increased depending on a response from the other apparatus as indicated by the LCD 12, the LED 13, and/or the audio output device 14.

The infrared radiation transmission and reception module 17 may be coupled to the CPU 11 and may cause infrared signals to be transmitted and received. That is, the infrared radiation transmission and reception module 17 may receive transmission pulses from the CPU 11, modulate the same according to a predetermined modulation technique such as pulse position modulation (PPM), and supply the modulated pulses or signal to the amplifier 16. Additionally, the infrared radiation transmission and reception module 17 may receive a signal from the photodiode 19, process the received signal such as by shaping the waveform thereof and demodulating the shaped signal, and supply the demodulated signal as reception pulses to the CPU 11.

The amplifier 16 amplifies the modulated signal received from the infrared radiation transmission and reception module 17 to a level in accordance with a transmission level control signal supplied from the CPU 11.

The infrared radiation light-emitting diode 18 may emit infrared radiation in accordance with the received amplified signal from the amplifier 16. That is, the infrared radiation light-emitting diode 18 may be energized by the signal or current supplied from the amplifier 16 to transmit a modulated signal as infrared radiation having a respective intensity level.

The photodiode 19 may function as a light-detecting device to detect transmitted infrared radiation and to generate a current or signal corresponding thereto. The photodiode 19 may be a PIN type photodiode. An output signal from the photodiode 19 may be supplied to the infrared radiation transmission and reception module 17.

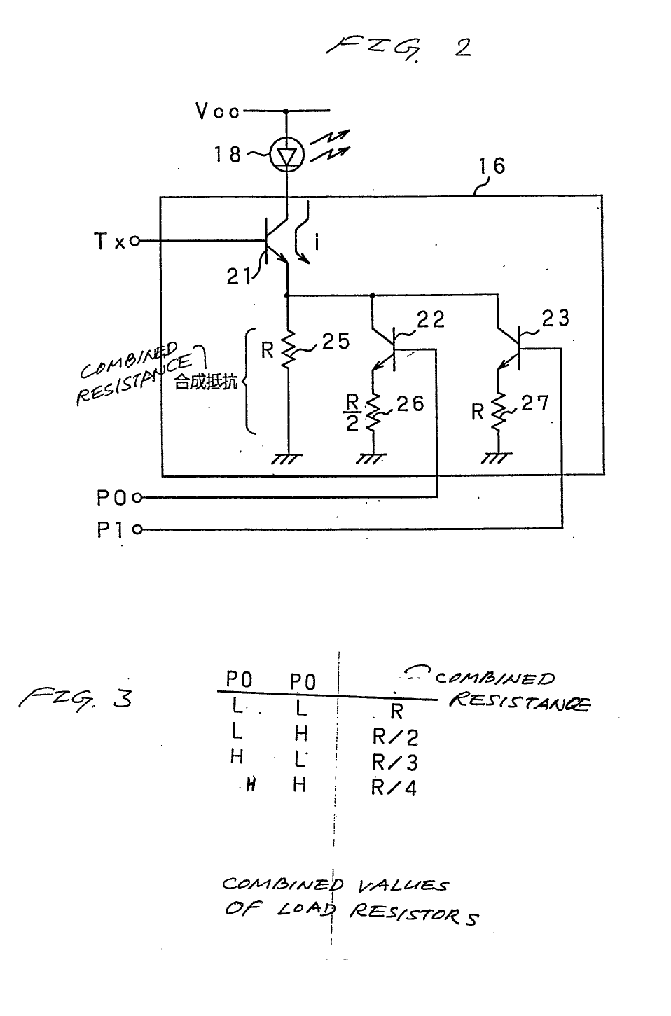

The amplifier 16 may function as a signal transmission intensity controller for increasing the transmission level of infrared pulses in a stepwise manner in response to a command signal from the CPU 11. A circuit arrangement of such amplifier or signal transmission intensity controller will now be described with reference to FIG. 2.

The amplifier or signal transmission intensity controller 16 may include a number of resistors, a first transistor 21, a second transistor 22, and a third transistor 23. Resistor 25, second transistor 22, and third transistor 27 may be coupled to the emitter of the first transistor 21 in a parallel arrangement.

The base of the first transistor 21 may be coupled to the infrared radiation transmission and reception module 17 by way of terminal Tx. The first transistor 21 may function as a switching device that can be turned on or off depending on the level of a signal supplied from the module 17 through terminal or port Tx to the base thereof. The infrared radiation light-emitting diode 18 may be connected as a load to the collector of the first transistor 21. As a result, the infrared radiation light-emitting diode 18 may be energized by a collector current (i) of the first transistor 21. The emitter of the first transistor 21 may be coupled to the resistor 25 which has a resistance R and to the second and third transistors 22 and 23.

The base of the second transistor 22 may be coupled to the CPU 11 by way of terminal P0. The second transistor 22 may function as a switching device that can be turned on or off depending on the level of a control signal supplied from the CPU 11 through terminal or port P0 to the base thereof. The collector of the second transistor 22 may be coupled to the emitter of the first transistor 21. The emitter of the second transistor 22 may be coupled to a resistor 26 having a resistance of R/2.

The base of the third transistor 23 may be coupled to the CPU 11 by way of terminal P1. The third transistor 23 may function as a switching device that can be turned on or off depending on the level of a control signal supplied from the CPU 11 through port or terminal P1 to the base thereof. The collector of the third transistor 23 may be coupled to the emitter of the first transistor 21. The emitter of the third transistor 23 may be coupled to a resistor 27 having a resistance R.

In the above-described arrangement, the command or control signal supplied from the CPU 11 to the amplifier or signal transmission intensity controller 16 may have four unique values (i.e., 2²=4, using 2 bits from output ports P0, P1) so as to enable up to four respective intensity levels to be specified.

The intensity of infrared pulses to be transmitted may be determined by the magnitude of the current i flowing through the infrared radiation light-emitting diode 18. The resistor 25 having resistance R, the resistor 26 having resistance R/2, and the resistor 27 having resistance R may be coupled together in a parallel arrangement and may be connected as load resistors to the emitter of the first transistor 21 for energizing the infrared radiation light-emitting diode 18.

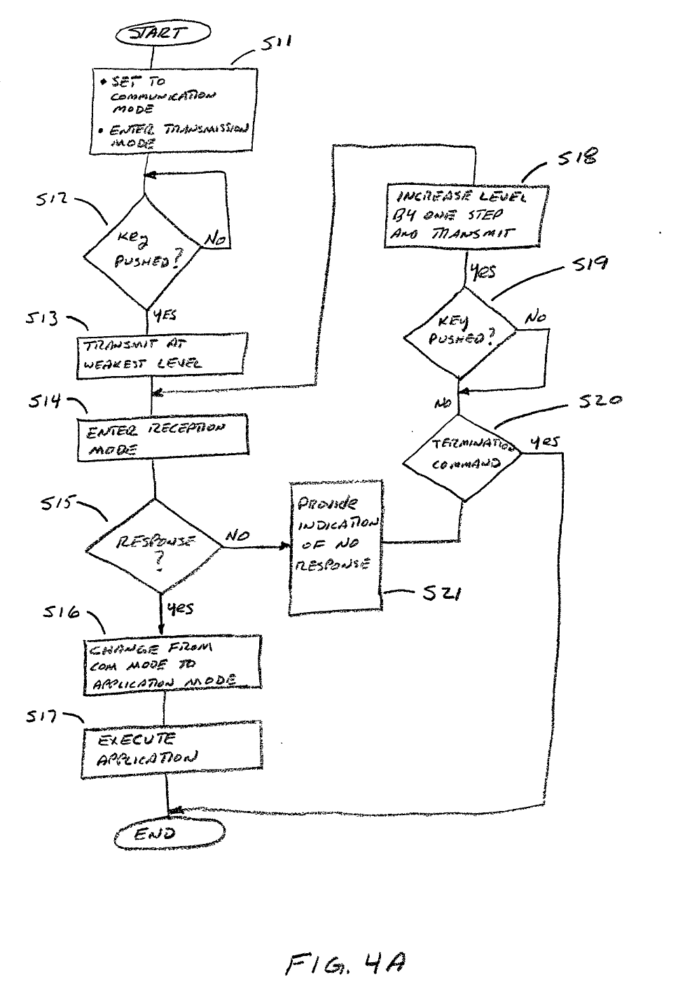

The resistors 26 and 27 may be respectively connected and disconnected by the transistor switches 22 and 23. The second transistor 22 and the third transistor 23 can be switched on or off (so as to connect or disconnect resistors 26 and 27) by use of the four unique control signals supplied from the CPU 11 by way of ports P0 and P1. The four logic combinations pertaining to the control signals supplied to the ports P0 and P1 enable combined resistances of the load resistors to be provided as shown in FIG. 3. That is, when the control signals supplied to the ports P0 and P1 produce logic levels LL, LH, HL, HH (where “L” and “H” respectively represent low and high signals), the resistors 25, 26, 27 may have combined resistance values of R, R/2, R/3, R/4, respectively. As a result, when the control signals supplied to ports P0 and P1 have logic levels LL, LH, HL, HH, the intensity of pulses to be transmitted can be increased in a stepwise manner such as from ×1 to ×2 to ×3 to ×4.

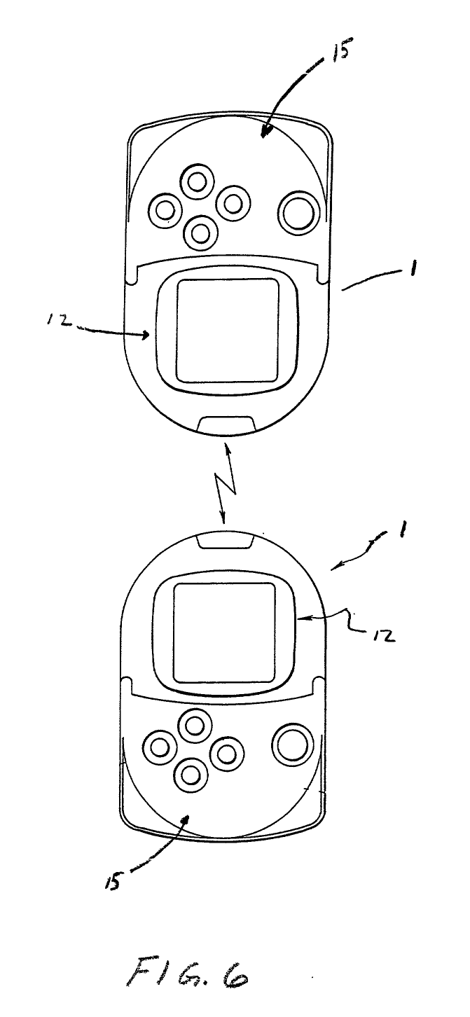

As previously indicated, the communication apparatus 1 is adaptable for bi-directionally communicating with another device such as another communication apparatus 1. An example of such arrangement is illustrated in FIG. 6. Although the arrangement of FIG. 6 indicates that a first communication apparatus 1 communicates with only a second communication apparatus 1, the present invention is not so limited. That is, the present communication apparatus 1 may communicate with any number of other devices or communication apparatuses.

Operations which may be performed by the present apparatus in a communication mode will now be described.

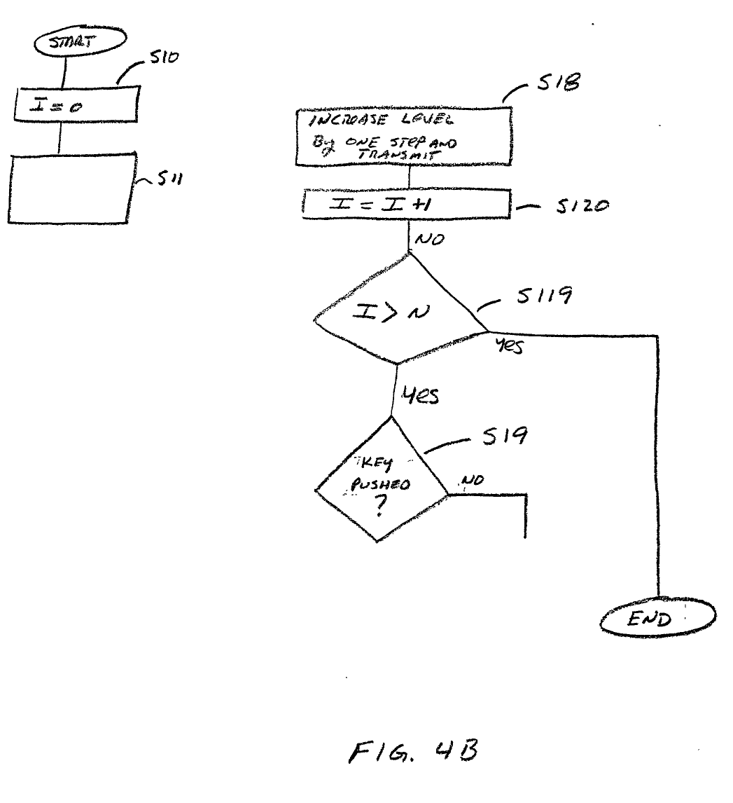

A manual operation will initially be described with reference to FIG. 4A.

At step S11, the CPU 11 may be set to a communication mode by use of the input device 15, whereupon the infrared radiation transmission and reception module 17 may be set to a transmission mode. Processing then proceeds to step S12, wherein a determination is made as to whether a key (such as input device 15) has been pushed or activated to trigger the transmission of a pulse. If such determination is negative, processing returns to step S12. If, however, the determination of step S12 is affirmative, processing proceeds to step 13 wherein an infrared pulse may be transmitted at the weakest level in one cycle or a predetermined number of cycles for reception by another communication apparatus.

When the transmission mode is finished, the infrared radiation transmission and reception module 17 and the CPU 11 may be set to a reception mode at step S14 so as to wait for a response from the other communication apparatus. Processing may then proceed to step S15 wherein a determination is made as to whether a response from the other communication apparatus has been received and confirmed by use of the LCD 12, the LED 13, and/or the audio output device 14. If such determination is affirmative, processing may proceed to step S16 wherein the communication mode is changed to an application mode. Thereafter, an application corresponding thereto may be executed at step S17. Upon completion of such application, the operation of FIG. 4A may be ended.

If, however, the determination at step S15 is negative, processing may proceed to step S21 whereupon an indication may be provided to a user that a response has not been received and inquiring whether the operation should be continued or terminated. Processing may then proceed to step S20 wherein a determination may be made as to whether the operation should be terminated. If the determination is affirmative (that is, the operation should be terminated), the operation is ended. On the other hand, if the determination at step S20 is negative (that is, the operation should not be terminated), processing may proceed to step S19 wherein a determination may be made as to whether a key (such as input device 15) has been pushed or activated so as to trigger the transmission of another pulse or pulses.

If the determination of step S19 is negative, processing of step S19 is repeated. On the other hand, if the determination of step S19 is affirmative, processing may proceed to step S18 whereupon an infrared pulse may be transmitted at an intensity level which is higher (such as by one increment or step) than the intensity level of the previously transmitted pulse or signal. Processing may then proceed to step S14 so as to wait for a response in the reception mode. Thereafter, processing similar to that previously described with regard to the steps after step S14 may be repeated. Further, if no response is received and/or no termination request is made, then each time the trigger button is pressed in step S19, the level of an infrared pulse may be increased in a stepwise manner in step S18 and the infrared pulse may be repeatedly transmitted. After the highest intensity level of an infrared pulse is obtained, the infrared pulse may be repeatedly transmitted at the highest intensity level. Alternatively, the transmission of the infrared pulse may be terminated after such pulse is transmitted at the highest intensity level and a response is not received within a predetermined time period from the other communication apparatus.

FIG. 4B illustrates a modification to the operation sequence shown in FIG. 4A.

The operation sequence of FIG. 4B includes step S119 in which a determination is made as to whether the number of times a pulse has been transmitted (I) is greater than a predetermined number N. (As an example, in the above arrangement having four intensity levels, N may be set to four.) If the determination of step S119 is affirmative, the operation may be ended. On the other hand, if the determination of step S119 is negative, processing may proceed to step S120 wherein I is increased by one. Thereafter, processing may proceed to step S18 in a manner similar to that previously described with reference to FIG. 4A. Additionally, the sequence of FIG. 4B may also include the step of S10 wherein I is set to 0 prior to step S11.

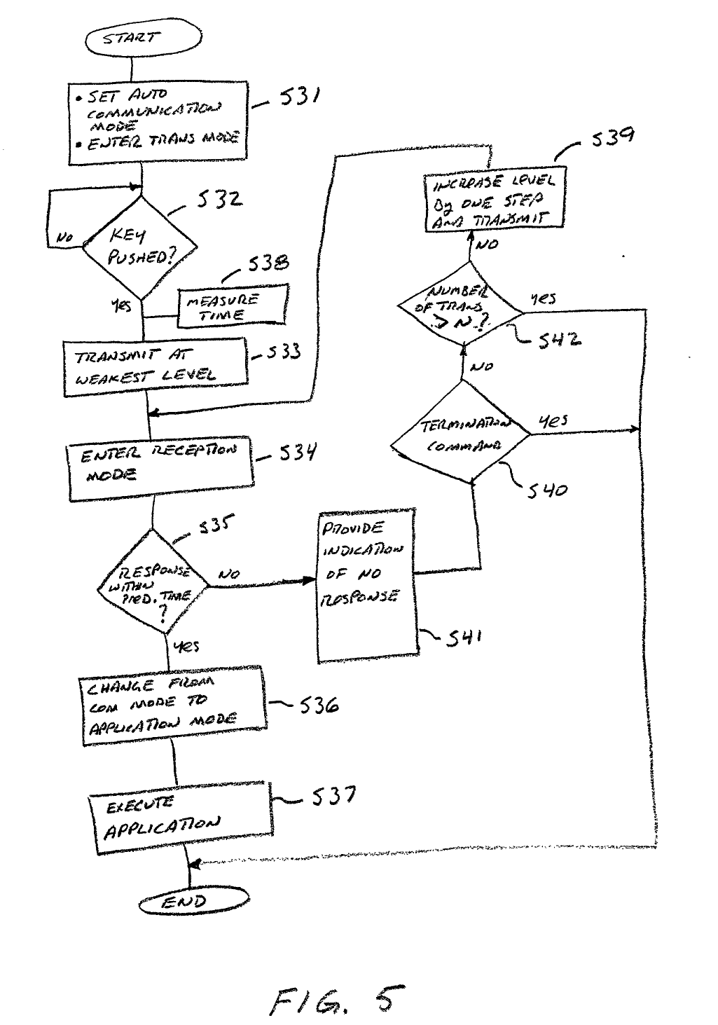

An automatic operation will now be described with reference to FIG. 5.

The automatic sequence operation shown in FIG. 5 is somewhat similar to the manual sequence operation of FIG. 4. Accordingly, and in the interest of brevity, only the differences therebetween will be described. (That is, the steps of the automatic sequence which are similar to those of the manual sequence will not be further described herein.)

At step S38, a timer may start measuring time when the trigger button (such as device 15) is pressed for the first time.

At step S35, a determination is made as to whether a response is received within a predetermined time period.

If the determination in step S40 is negative, processing may proceed to step S42 wherein a determination is made as to whether the number of times the pulse has been transmitted and/or re-transmitted exceeds a predetermined number N. If such determination of step S42 is affirmative, the operation may be ended. However, if the determination of step S42 is negative, processing may proceed to step S39. As a result, the intensity level of a pulse may be automatically increased without manually pressing a button or input device.

The intensity levels of pulses to be transmitted in the automatic sequence may be read from a table stored in a memory (such as memory 9). Such table may contain levels corresponding to present values of the timer which is started when the trigger button is initially pressed. Alternatively, a pulse may be transmitted at an intensity level which is one step higher than the previous level.

Additionally, the operation sequence of FIG. 5 may include steps similar to steps S10 and S120 of FIG. 4B which may be respectively arranged prior to step S31 and prior to step S39 in a manner similar to that previously described with reference to the sequence of FIG. 4B.

Further, although the above operation sequences of the present apparatus were described as having certain steps, the present invention is not so limited. That is, such operations may be modified. For example, in the operation sequence of FIG. 5, steps S41 and/or S40 may be eliminated.

Accordingly, the present invention provides a communication apparatus having a bidirectional radio communication function for initially transmitting a signal at a weak level for reception by another communication apparatus, and in the absence of a response from such other communication apparatus, for increasing the level in a stepwise manner and repeatedly transmitting the signal at increased levels so as to obtain an optimum communication situation even under varying or adverse conditions.

Although the present invention as described above utilizes infrared radiation, the present invention is not so limited and may instead utilize radio waves and so forth.

Therefore, the present invention provides a communication apparatus wherein for radio communications with another communication apparatus at a relatively short distance, acceptable communication conditions can be manually or automatically adjusted depending on the ambient environment. Since radio communications may be susceptible to shields and disturbance noises, it is advantageous to be able to adjust the intensity level of a signal to be transmitted to an optimum level. Additionally, by increasing the intensity level in stepped increments, instances where the intensity level is so large that it will adversely affect reception devices other than the desired reception apparatus may be greatly reduced. Furthermore, the amount of power needed for transmitting a signal may be minimized since the signal may be first transmitted at a weak or relatively low level.

Although preferred embodiments of the present invention and modifications thereof have been described in detail herein, it is to be understood that this invention is not limited to these embodiments and modifications, and that other modifications and variations may be effected by one skilled in the art without departing from the spirit and scope of the invention as defined by the appended claims.

What is claimed is:

1. A communication apparatus for bidirectionally transmitting and receiving a signal through a radio circuit, comprising a transmitting device for transmitting a signal, drive means for driving said transmitting device to transmit the signal, control means for controlling said transmitting device and said drive means, and signal transmission intensity control means for controlling an intensity with which the signal is transmitted.

2. A communication apparatus according to claim 1, wherein said control means controls said signal transmission intensity control means to increase the intensity of a signal transmitted by said transmitting device when a response is not received to the signal transmitted by said transmitting device.

3. A communication apparatus according to claim 2, wherein said control means increases the intensity of a signal stepwise after the signal is transmitted at a weak level controlled by said signal transmission intensity control means.

4. A communication apparatus according to claim 1, further comprising display means for displaying whether there is a response to a signal transmitted by said transmitting device or not, and inputting means for entering an input to said signal transmission intensity control means to increase the intensity of a signal transmitted by said transmitting device stepwise.

5. A communication apparatus according to claim 1, wherein the signal is transmitted and received by way of infrared radiation.

6. A communication method for bidirectionally transmitting and receiving a signal through a radio circuit between a plurality of communication devices, said method comprising the steps of:
transmitting a signal from one of the communication devices to another communication device;
receiving a response from said other communication device at said one communication device; and
increasing stepwise an intensity of a signal transmitted from said one communication device to said other communication device depending on the received result.

7. A communication method according to claim 6, further comprising the steps of displaying whether there is a response to a signal from said other communication device or not, and entering an input to increase the intensity of the transmitted signal stepwise.

8. A communication method according to claim 6, wherein the increasing step includes increasing the intensity of a signal transmitted from said one communication device to said other communication device if there is no said response from said other communication device.

9. A communication method according to claim 6, wherein the signal is transmitted and received by way of infrared radiation.

10. A signal transmitting and receiving apparatus comprising:
means for transmitting a transmission signal at a first intensity level for reception by a receiving device;
means for receiving a response from said receiving device indicating that said receiving device received the transmission signal; and
means for re-transmitting the transmission signal at a second intensity level higher than the first intensity level when the response is not received by the receiving means after the transmitting means transmits the transmission signal at the first intensity level.

11. An apparatus according to claim 10, further comprising means for displaying the response.

12. An apparatus according to claim 10, wherein the transmitting means transmits said transmission signal by way of infrared communication.

13. An apparatus according to claim 12, wherein the receiving device supplies said response to the receiving means by way of infrared communication.

14. A signal transmitting and receiving apparatus comprising:
means for transmitting a transmission signal at a first intensity level for reception by a receiving device;
means for receiving a response from said receiving device indicating that said receiving device received the transmission signal; and
means for automatically re-transmitting the transmission signal at a second intensity level higher than the first intensity level when the response is not received by the receiving means after the transmitting means transmits the transmission signal at the first intensity level.

15. An apparatus according to claim 14, further comprising means for displaying the response.

16. An apparatus according to claim 14, wherein the transmitting means transmits said transmission signal by way of infrared communication.

17. An apparatus according to claim 16, wherein the receiving device supplies said response to the receiving means by way of infrared communication.

18. A signal transmitting and receiving apparatus comprising:
means for transmitting a transmission signal at an intensity level obtained from among a number of N intensity levels for reception by a receiving device;
means for receiving a response from said receiving device indicating that said receiving device received the transmission signal; and
means for re-transmitting the transmission signal at another intensity level obtained from among the intensity levels which is higher than the previously obtained intensity level when the response is not received by the receiving means after the transmitting means transmits the transmission signal at the previously obtained intensity level.

19. An apparatus according to claim 18, wherein the re-transmitting means retransmits the transmission signal until the response is received by the receiving means or until the transmission signal has been transmitted N times each time at an intensity level higher the preceding time.

20. An apparatus according to claim 19, further comprising means for displaying the response.

21. An apparatus according to claim 19, wherein the transmitting means and the re-transmitting means transmits the transmission signal by way of infrared communication.

22. An apparatus according to claim 21, wherein the receiving device supplies said response to the receiving means by way of infrared communication.

23. A method for transmitting and receiving a signal, said method comprising the steps of:
transmitting a transmission signal at a first intensity level for reception by a receiving device;
receiving a response from said receiving device indicating that said receiving device received the transmission signal; and
re-transmitting the transmission signal at a second intensity level higher than the first intensity level when the response is not received after transmitting the transmission signal at the first intensity level.

24. A method according to claim 23, further comprising displaying the response.

25. A method according to claim 23, wherein the transmitting step transmits said transmission signal by way of infrared communication.

26. A method according to claim 25, wherein the receiving device supplies said response by way of infrared communication.

27. A signal transmitting and receiving method comprising the steps of:
transmitting a transmission signal at a first intensity level for reception by a receiving device;
receiving a response from said receiving device indicating that said receiving device received the transmission signal; and
automatically retransmitting the transmission signal at a second intensity level higher than the first intensity level when the response is not received after the transmitting step transmits the transmission signal at the first intensity level.

28. A method according to claim 27, further comprising displaying the response.

29. A method according to claim 27, wherein the transmitting step transmits said transmission signal by way of infrared communication.

30. A method according to claim 29, wherein the receiving device supplies said response by way of infrared communication.

31. A signal transmitting and receiving method comprising the steps of:
transmitting a transmission signal at an intensity level obtained from among a number of N intensity levels for reception by a receiving device;
receiving a response from said receiving device indicating that said receiving device received the transmission signal; and
re-transmitting the transmission signal at another intensity level obtained from among the intensity levels which is higher than the previously obtained intensity level when the response is not received after the transmitting step transmits the transmission signal at the previously obtained intensity level.

32. A method according to claim 31, wherein the re-transmitting step retransmits the transmission signal until the response is received or until the transmission signal has been transmitted N times each time at an intensity level higher the preceding time.

33. A method according to claim 32, further comprising displaying the response.

34. A method according to claim 32, wherein the transmitting step and the re-transmitting step transmits the transmission signal by way of infrared communication.

35. A method according to claim 34, wherein the receiving device supplies said response by way of infrared communication.
